(19) United States
(12) Patent Application Publication
(10) Pub. No.: US 2018/0248892 A1
(43) Pub. Date: Aug. 30, 2018

(54) Location-Based Continuous Two-Factor Authentication

(71) Applicant: Guy Hefetz, Boca Raton, FL (US)

(72) Inventor: Guy Hefetz, Boca Raton, FL (US)

(21) Appl. No.: 15/964,187

(22) Filed: Apr. 27, 2018

Related U.S. Application Data
(63) Continuation-in-part of application No. 15/606,270, filed on May 26, 2017.
Application No. 15/606,270 is a continuation-in-part of application No. 15/134,545, filed on Apr. 21, 2016, now Pat. No. 9,727,867.
Application No. 15/134,545 is a continuation-in-part of application No. 14/835,707, filed on Aug. 25, 2015, now Pat. No. 9,391,985.

(51) Int. Cl. H04L 29/06; H04W 12/06

(52) U.S. Cl. CPC H04L 63/107; H04L 2463/082; H04L 63/08; H04W 12/06

(57) ABSTRACT

The invention provides a means of continuous two-factor authentication, wherein location information is collected by a client mobile device and transmitted to an authentication platform at the beginning of a communication session. The location information is correlated with a unique identifier of the communication session, derived from server-generated components such as destination IP address, destination TCP port, tty terminal device, and the like. If the mobile device changes location by more than a predetermined amount, the correlation is broken, and re-authentication by the user is required in order to continue the session.

### CROSS-REFERENCE TO RELATED APPLICATIONS

This application is a continuation-in-part of U.S. patent application Ser. No. 15/606,270, filed May 26, 2017, which is a continuation-in-part of U.S. patent application Ser. No. 15/134,545, filed Apr. 21, 2016, now U.S. Pat. No. 9,727,867, which is a continuation-in-part of U.S. patent application Ser. No. 14/835,707, filed Aug. 25, 2015, now U.S. Pat. No. 9,391,985.

The contents of each one of the above prior applications is incorporated herein by reference in its entirety.

### FIELD OF THE INVENTION

The invention relates to the field of authenticating the identity of users or clients of computer networks, more specifically to methods of two-factor authentication.

### BACKGROUND OF THE INVENTION

Two-factor authentication (“2FA” or “TFA”) is a method of confirming a user's claimed identity by utilizing a combination of two different factors, selected from 1) knowledge factors, something the user knows, 2) possession factors, something the user has, or 3) inherence factors, something the user is. Withdrawing cash from a ATM, for example, requires the correct combination of a bank card (something that the user has) and a PIN (something that the user knows) before the transaction can be carried out. Biometric scans of fingerprints or users' retina are examples of “something that the user is.”

Two-step authentication is a variation employing something the user knows (e.g. a password or PIN) in combination with a second factor that the user temporarily knows via an “out-of-band” (second channel) mechanism. The second step is typically the provision of a four- to six-digit number, transmitted as a text message or e-mail, or a code generated by an application or token that is common to the user and the authentication system. The device on which the code is received, or the token, is a possession factor.

Continuous two-factor authentication is a variation that requires repetition of the authentication protocol at intervals or upon triggering events. It prevents a fraudster from taking the place of the authentic user after a session has been authenticated. An example is an ATM that requests re-entry of a user's PIN after a balance inquiry, or a session timeout, after a period of inaction, requiring that a password be re-entered.

There are methods for continuous and multiple two-factor authentication that require only one user interaction. Some of these methods identify unique and/or common identifiers in a tablet, smart phone, or other portable computing device, and assign these device identifiers to the user identity or the user's device in order to validate future transactions based on historic authenticated data. The presence of this device at the location of the user, detected by wireless means, serves as a second factor. Such methods use protocols and software clients like Internet browsers that transfer software and hardware identifiers of the user's computer to the server that the computer is communicating with. The server relies on these identifiers to “recognize” the device being used as having been employed by the user in a previous session. Generally, such methods do not delete historic correlations between the computer identifiers and the mobile voice device. For the purposes of this specification, mobile voice devices are defined in U.S. patent application Ser. No. 13/479,235 filed on May 23, 2012.

For some computer protocols, such as Linux/Unix SSH/Terminal (“SSH”), it is not possible for the server to receive an identifier of the computer because the SSH (Secure Shell) protocol does not transfer such data to the server. These methods will therefore not work with a protocol such as SSH.

There is a need for continuous two-factor authentication when protocols such as SSH are used. It is especially desirable to provide SSH communication with the capability of continuous automated two-factor authentication without the user having to repeatedly interact with two-factor authentication (“TFA”) software or messages on a mobile voice device.

Providing background TFA without user intervention substantially increases security because such security can be configured to be used at regular intervals, or upon user-triggered events, in the background without user intervention. Requiring the user to manually authenticate every few minutes is extremely inconvenient, and incurs costs in connection time, bandwidth usage, and mobile voice device battery life.

Some prior art systems rely on checking that the mobile phone is near the computer by getting captured data from the mobile phone. In such cases it is possible for a hacker to access the computer while the user is seated nearby, and initiate a connection to an SSH server. The disadvantage of such prior art methods is that while the phone is near the user's computer, it is not possible to know whether the connection was initiated by the user or by a hacker.

There is a need for systems, such as that of the present invention, which authenticate a connection between the user's computer and a server and, if the authentication is successful, make it possible to re-authenticate upon actions triggered by the user, such as a request for elevated permissions, a change in username, access to a privileged file, installation of an application, etc. without the user having to interact with his mobile phone every time a two-factor authentication needs to be carried out.

### BRIEF DESCRIPTION OF THE INVENTION

The term “continuous two-factor authentication” as used herein refers to repetitive two-factor authentication during the course of a communication session. The repeated authentications can be nearly continuous, i.e. at a high frequency, or at any desired time interval (e.g. once per minute, or once per hour), or may be triggered by selected events or periods of inaction. The smart phones, tablets, notebook and laptop computers, and equivalent devices used to provide the second authentication factor for a communication session are generically referred to herein as “mobile devices”.

The present invention allows continuous and multiple two-factor authentication using the user's mobile device and a Server Session Signature (SSS), where the Server Session Signature does not contain any hardware or software identifiers of the user's mobile device. The invention enables the user to interact with his mobile phone only once, without requiring additional two-factor authentication from the user for the same communication session. The mobile device serves as a possession factor in this authentication process.

The invention employs a Two-Factor Authentication (TFA) platform. The TFA platform comprises a networked computer having memory and a processor, configured to carry out the steps of the invention as described herein. The TFA platform may be implemented in the memory and processor of the server, or in a separate networked computer that may be local or may be remotely located. A TFA platform according to the invention may provide authentication services for a plurality of servers.

Briefly, a user initiates communication from a computer to a server via an open port on the server. Before allowing access to the computer, the server authenticates the user identity by, in the majority of cases, requiring a username and password. Upon successful authentication, communication between the computer and the server is established. The presence of a mobile device in the possession of the user is then detected wirelessly, and the mobile device is interrogated for the Short Distance Wireless Information (SDWI) that uniquely characterizes the location of the device.

In some cases, after a successful login into the server, the authenticated user might want or need to get elevated permissions. The requirement for elevated permissions is triggered by the user. User actions that trigger an elevation in permissions may include, for example, accessing a file, changing the username, executing/deleting/copying or editing a file, installing an application, making changes to specific system files or configurations, accessing a file that the user never accessed before, or explicitly requesting elevated permissions. The system itself can trigger a re-authentication upon detection of certain events, such as the passage of time, the identification of a particular communication, the identification of a particular user action, or the identification of abnormal/unusual user behavior.

Elevated permissions are required, for example, in order to allow the user to edit a restricted file. Two existing platforms for managing elevated permissions include Sudo (“SU”) and PowerBroker (“PB”). If an elevated permission platform such as SU or PB is implemented, and the user requests such elevated permissions, the user will need to be authenticated again, and, if the authentication is successful, the user will gain the elevated permissions. In some cases, for security or auditing reasons, companies will require authentication for elevated user action per command, in order to verify that the user that enters each command is an authenticated user.

The server, in the present invention, generates a Server Session Signature (“SSS”), an identifier assigned by the server to the particular session of communication between the user's computer and the server. The SSS is a unique identifier for the communication session for which it is generated. The SSS may be derived from one or more components, including but not limited to: destination IP (the user's computer public IP address), destination TCP port, local port, TID (Thread ID), SID (session ID), PPID (parent process ID), UID (User ID), PID (Process ID), PGID (process group ID), GID (Group ID), and tty terminal device. The method of the invention correlates the SSS with the mobile device SDWI at the beginning of the session, and subsequently can re-authenticate the user by automatically fetching SDWI from the mobile device and checking the correlation, without user intervention. If the device has changed location sufficiently to alter the SDWI, the automatic authentication fails, and the user's input is once again required.

Hackers will often target IT departments in an attempt to get elevated permission credentials. Hackers that successfully get the username and password of an elevated permission user gain full access to the entire server and, in many cases, have caused major disruptions, theft of data, and damage to the company's reputation. Companies attempt to defeat such hacking attempts by implementing two-factor authentication (TFA). The challenge with TFA platforms is that TFA requires user interaction at least twice: once upon logon, and a second time upon initiating each elevated request via SU or PB. Some SU and PB configurations may require that the user be authenticated via TFA for every command. TFA is a major inconvenience for the user because the user needs to interact with his device every time a TFA is required. The present invention provides a substantial improvement in obtaining an elevated user permissions, by providing a TFA platform that authenticates the user multiple times via the user's mobile device while only requiring a single user interaction with the mobile device. In some embodiments, no user interaction at all is required.

### BRIEF DESCRIPTION OF THE FIGURES

FIG. 1 is a flow chart showing the operations of the present invention.

### DETAILED DESCRIPTION OF THE INVENTION

The invention is a method of two-factor authentication based upon the use of a user's mobile voice device as a possession factor in TFA. The mere physical presence of the mobile device, typically accomplished via the mobile device's broadcast, over Wi-Fi, of its MAC address or SSID, is used in prior art methods as an authentication factor. In the present invention, this is augmented or replaced by the acquisition of mobile location information (MLI) from the mobile device, captured by a mobile application. A subset of MLI is “SDWI”, Short Distance Wireless Information. As used herein, the term refers to information that is broadcast wirelessly for a short distance (usually under 50 m) between a mobile device and a second wireless device. Such transfers of information may be initiated automatically, or triggered by the user of the mobile voice device. The information is typically transferred via a short-range wireless technology such as Bluetooth, Wi-Fi or RFID (e.g., NFC), and contains mobile location information (MLI) associated with the mobile voice device that is characteristic of its present location. Examples of such MLI include internal and external network IP addresses, the mobile voice device's geo-location (e.g. from GPS), and the Wi-Fi Mac addresses, SSIDs, and signal strengths of nearby wireless devices. Examples of ambient SDWI detected by the mobile device include but are not limited to MAC addresses and SSIDs of computers, printers, and routers, and router and gateway IP addresses. U.S. Pat. No. 9,391,985, incorporated herein by reference, provides a detailed description of the acquisition and use of SDWI by mobile devices, and the use of SDWI for authentication purposes.

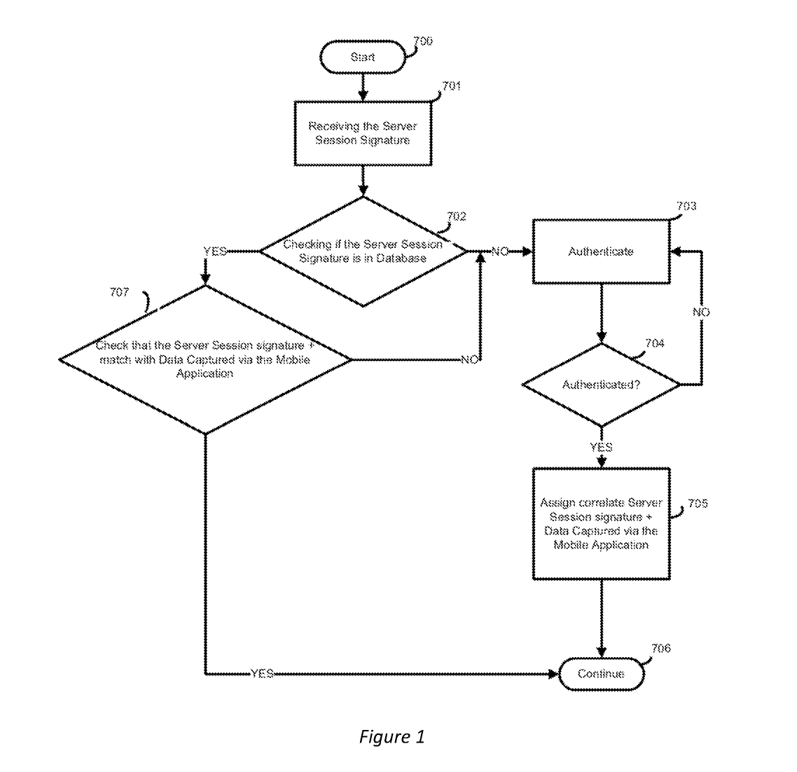

Turning to FIG. 1, a particular embodiment is shown as a flow chart. At step 700, the operation starts when a user initiates a session with a server. At step 701, the server generates a Server Session Signature. The Server Session Signature (“SSS”) is an identifier assigned by the server to the particular session of communication between the user's computer and the server. The SSS is based on the server's available resources, and although it is not unique to any particular user's computer, or to any server or computer on the Internet, it is an identifier for the session for which it is generated. The SSS can be derived from one or more of the following components: destination IP (user's computer public IP address), destination TCP port, local port, TID (Thread ID), SID (session ID), PPID (parent process ID), UID (User ID), PID (Process ID), PGID (process group ID), GID (Group ID), and terminal device (e.g. /dev/pts/0) as assigned by, for example, Linux command tty, which is responsible for directing output and input to the correct login session and the correct socket. The terminal device is uniquely assigned for each Login session. It is possible to use one identifier or combination of identifiers in order to safely track the communications with the user's computer. The SSS may be a list, string or array comprising the various port and ID components, or it may be the result of a calculation that uses the components as inputs. In certain embodiments, the SSS components may be encrypted, or combined components may be encrypted into a single number or string. The encrypted number may be of any desired length, from 16- or 32-bit up to 256 bits. The SSS is received by the two-factor authentication (TFA) platform, which maintains a database and interrogates it as part of the authentication process.

At step 702, the TFA platform checks for the presence of a matching Server Session Signature (or corresponding encryption) in a database. If yes, the platform continues to step 707. If no, the platform continues to step 703.

If there is no matching Computer Information and SSS in the database, authentication commences at step 703. At this point, any prior art method of authenticating the user may be employed. The authentication can be done using a mobile application, such as a client software mobile application installed on the mobile voice device as described in U.S. Pat. No. 9,391,985 (issued Jul. 12, 2016.) Such authentication can take place by sending a push notification to the mobile application, subsequent capture of SDWI data by the mobile application, and having the user authorize the authentication by allowing the transmission of the information. Other methods of authentication are also possible such as via SMS, phone call, etc. The mobile application running on the mobile voice device can capture a variety of data and environmental information, including but not limited to geo-location, WiFi data such BSSID and SSID, the mobile phone's Wi-Fi IP address, noise, sound captured by the phone, phone position and motion, the phone's internal IP address, the router's IP address that the phone is connected to, and the like. The authentication can be performed by presenting the computer information, server session information, username, the operation that the user is trying to perform, a session identifier presented to the user on the computer and in the authentication, the port accessing the server, etc.

Some organizations may choose not to require authorization through the user if specific information is captured by the mobile application. For example, the user may be authenticated if data captured via the phone matches with the data of the computer, or if data captured via the phone matches with data of the phone of a second user who has already been successfully authenticated. Such data can include SDWI or MLI, for example, IP address, Wi-Fi SSID, Wi-Fi BSSID, sound, location, geo-location, and wireless identifiers. The computer can be the mobile voice device running the mobile application and accessing the server, or the mobile voice device and the computer can be two separate devices.

At step 704, if the information provided by the user has been authenticated, the process proceeds to step 705. If the information provided by the user is not authenticated, the system can attempt to authenticate again, or alternatively provide the option of blocking future attempts at communication. A blacklist of future communications (e.g., “Blocked IP Addresses”) to be blocked by a firewall can be maintained. For example, when the user in possession of the mobile device chooses to deny authentication, the platform could have the option that if the user denies once or twice, or selects a “Firewall” option, the IP address that tried to access the server would be automatically added to “Blocked IP Addresses”, and the firewall would automatically block future communication from that IP address. Another option can be maintaining a list of “White List IP Addresses” on the platform. Even if a user clicks “Deny” or “Firewall” by mistake, if the IP address is in the “White List IP Addresses,” that IP address will not be blocked by the firewall. An additional option can be to automatically synchronize the “Blocked IP Addresses” (minus the “White List IP Addresses”) across an entire organization's servers, or specific servers in the organization, so that once a user blocks an IP address, all servers would automatically block the same IP address. In some cases, different companies may elect to merge or share their “Blocked IP Addresses” lists, so that when one user working for a first company elects to “Deny” or “Firewall” an attempted connection, a second company would use the first company's “Blocked IP Addresses” to block that IP addresses from their own servers, unless the IP address is in their own “White List IP Addresses.”

If the information is authenticated, at step 705 the platform correlates data captured by the mobile application with data captured by the server, and stores the data and the correlation in a database. Examples of data captured by mobile application include, but are not limited to, IP address, WiFi SSID, WiFi BSSID, sound, location, geo-location, and wireless identifiers. Unlimited example of data captured by the server include but are not limited to destination TCP port, local port, TID (thread ID), SID (session ID), PPID (parent process ID), UID (user ID), PID (process ID), PGID (process group ID), GID (group ID), and destination IP (the user's computer public IP address), as well as a Server Session Signature derived from one or more of these components. The correlation between the data captured by the server to the captured data by the mobile application can be a temporary correlation, which can have a fixed lifetime or be maintained until the user terminates the session with the server. A preferred method to terminate the correlation is to terminate the correlation once the server identifies that the session is closed. Once the server identifies that the session is closed, the server will send a notification to terminate the correlation.

After successful data correlation or after successful data verification the TFA platform would continue at step 706. At 706, notification of successful authentication can be sent to the server, and the session can be allowed to proceed.

Step 707, if the SSS is found to already be in the database, the TFA platform checks whether the data correlated with the Server Session Signature matches the data captured via the Mobile Application. If the data doesn't match, the process proceeds to step 703 for authentication by other means. If the data does match, the platform concludes that the user is still at the computer, in an already-authorized session, and proceeds to step 706.

Since the Server Session Signature is data assigned by the Server for a particular communication between the server and the user's computer, preferred embodiments will delete the correlation between the Server Session Signature and SDWI as a security and privacy measure.

It is possible to monitor the communications between the server and the user's computer, and if the user decides to close the communication or if the server closes/times out the communication, it is possible to delete the Server Session Signature or to mark the Server Session Signature as inactive or expired. Alternatively, practitioners may choose to retain the correlation between the Server Session Signature and SDWI in order to improve the user's experience in future sessions. This may be desirable in controlled office settings, where workers login to the same servers from the same computers on a regular basis.

In one embodiment of the invention, the TFA platform transfers the SSS authentication information (e.g., IP address+Port) to the mobile phone. The mobile phone, based on the SDWI and the user's decision to allow access, will then transfer a message back to the TFA platform, indicating successful authentication. In this embodiment, the TFA platform is not informed whether the authentication is based upon the user clicking “Allow” or upon the SDWI information being consistent with a previous authentication. Because a part of the authentication data (in particular, private data) is saved locally on the user's phone instead on a central system, a party that hacks into the TFA platform database will not have access to all of the user's information. This increases security, protects user privacy, and reduces risk for the party that manages the TFA platform.

### EXAMPLE

The following sequence of events represents the experience of a user interacting with a computer network on which the methods of the invention are in use:
1. A user using a computer that has public IP 75.45.30.10 initiates a connection to a server (“SSH Server”). The SSH server has the public IP 50.54.52.67. (SSH normally uses TCP port 22)
   a. Optional: The server presents a few authentication methods and lets the user select his preferred authentication method.
   b. Very important: The server presents a unique session ID, which will also be sent to the user mobile application.
   c. Optional: The user selects the authentication method.
2. The user provides indication of his identity, mostly by entering his username and password.
3. The SSH server authenticates the user identity.
4. The SSH server identifies that the user's computer destination IP is 75.45.30.10, and the user's computer destination TCP port is 56342, and sends that information to the TFA platform for authentication. Optional: send the unique session ID to the user.
5. The TFA platform receives the user's computer destination IP 75.45.30.10 and the user's computer destination TCP port 56342 and checks if such correlation already exists in the database.
6.Because there is no correlation of the user's computer destination IP 75.45.30.10 and the user's computer destination TCP port 56342, the user receives an authentication push notification request in his mobile application. The authentication request may contain the username, computer Destination IP, the server name, the server service and TCP port 22, date, time, unique session ID, or other SSS components. Preferably, only a few components, or only one component is presented for the user to identify in his Mobile Application, such as the unique session ID. The benefit of presenting just one component is to keep the user's attention focused on important information. The user decides to click “Allow,” and the mobile application captures data such as IP address, WiFi SSID, WiFi BSSID, Sound, Location, Geo-Location, Wireless identifier and sends that information back to the TFA platform.

During protocol negotiation between a server and a user's computer, even before the user enters his username and password, the server determines the destination TCP port for the particular communication session between the user's computer and the server. The TCP port status will be “Established” and have the same TCP port number as long as the user continues to use the current session. If the user closes the session, or if the server terminates the session, then the TCP port status will change to “Close Wait”. If the user opens a new session, using the same computer and the same server, the new session will have a different port number assigned by the server. By using a command like “netstat” it is possible to capture the change in the TCP port status from “Established” to “Close Wait” or any other TCP status, and delete or terminate a correlation between the port and the SDWI or MLI.
7. The TFA platform receives the “Allow” response from the user and the mobile application captures data.
8. The TFA platform correlates the user's computer destination IP 75.45.30.10 and the user's computer destination TCP port 56342 with the data captured by the mobile application and allows the user to continue by providing an approval notification to the SSH server.
9. The SSH server receives the approval notification and allows the user to access.
10. The user decides to change his username to an elevated username or, alternatively, the user decides to enter a command that requires an elevated permission, by using a platform such as Sudo or PowerBroker.
11. The SSH server identifies that the user's computer destination IP is 75.45.30.10 and the user's computer destination TCP port is 56342.
12. The TFA platform receives the user's computer destination IP 75.45.30.10 and the computer destination TCP port 56342, and checks whether they are correlated in the database.
13. Since the correlation exists, the TFA platform sends a push notification to the mobile phone application and receives MLI and SDWI data captured by the mobile application, such as IP address, WiFi SSID, WiFi BSSID, Sound, Location, Geo-Location, Wireless identifier, or the like.
14. The TFA platform checks the data correlation captured by the mobile application against historic approved captured and correlated data. If the historic data correlation matches, the TFA platform provides an “Allow” access notification to the SSH server.
15. The user decides to close his SSH session.
16. The server identifies that the SSH session is closed or that the TCP port 56342 status is not “Established” anymore, (e.g. the TCP port status may be “Time Wait” or “Close_Wait”.)
17. The server sends a notification to the TFA platform that TCP port 56342 has changed status.
18. The TFA platform deletes the correlation between the mobile application data (SDWI and MLI) and destination IP 75.45.30.10 and TCP port 56342.

The method of the invention does not rely on correlating the destination IP, and can operate by correlating only a single SSS component such as Destination TCP port or terminal device. A preferred embodiment employs both Destination TCP port and terminal device. The result is a convenient and nearly transparent maintenance of two-factor-authenticated status.

I claim:

1. A computer-implemented method of controlling the access of an Internet user to a server via a computer, where the user has access to a mobile voice device that is paired with an identifier of the user, the method comprising the computer-implemented steps of:
(a) receiving a Server Session Signature;
(b) receiving the identifier of the user;
(c) determining whether the Server Session Signature is stored in a database;
(d) sending a notification from an authentication platform to the mobile voice device that is paired with the identifier received in step (b), the notification causing the mobile voice device to acquire Short Distance Wireless Information (SDWI) and to present to the user a request to allow access to the server;
(e) if the Server Session Signature is not in the database, associating, and storing in the database, the SDWI with the Server Session Signature; and
(f) communicating an indication of user validation to the server; otherwise,
(g) sending a notification from the authentication platform to the mobile voice device that is paired with the identifier received in step (b), the notification causing the mobile voice device to acquire SDWI;
(h) if the Server Session Signature is in the database, determining whether the SDWI acquired at step (g) matches the SDWI stored at step (e); and
(i) if the SDWI acquired at step (g) matches the SDWI stored a step (e), then communicating an indication of successful user validation to the server.

2. The method of claim 1, wherein the Server Session Signature is the destination TCP port of the user's computer.

3. The method of claim 1, wherein the SDWI comprises wireless information from a wireless device that is independent and separate from both the mobile voice device and the computer.

4. The method of claim 3, wherein the SDWI is one or more selected from the group consisting of Wi-Fi MAC address, Wi-Fi SSID, and Wi-Fi signal strength.

5. The method of claim 1, Wherein the Server Session Signature being derived from one or more session parameters selected from the group consisting of destination TCP port, local port, TID (Thread ID), SID (session ID), PPID (parent process ID), UID (User ID), PID (Process ID), PGID (process group ID), GID (Group ID) and terminal device.

6. The method of claim 1, further comprising the steps of
(j) receiving a notification that the user has ended communication between his computer and the server; and
(k) deleting the correlation between the SSS and the SDWI.

7. The method of claim 1, further comprising, if the SDWI received at step (g) does not match the SDWI stored at step (e):
(j) sending a notification from an authentication platform to the mobile voice device that is paired with the identifier received in step (b), the notification causing the mobile voice device to acquire Short Distance Wireless Information (SDWI) and to present to the user a request to allow transmittal of the SDWI;
(k) receiving the transmitted SDWI, storing the SDWI in the database, and associating, in the database, the SDWI with the Server Session Signature; and
(l) communicating an indication of successful user validation to the server.

8. The method of claim 1, further comprising, if the SDWI acquired at step (g) does not match the SDSWI stored at step (e), attempting to authenticate the user by other means.

9. The method of claim 1, further comprising presenting options to the user, via software installed on the mobile voice device; the options including at least one of: (a) block with a firewall future access from the computer IP address, and (b) the option to use the association of SDWI and computer signature of another user.

10. The method of claim 1, wherein the Server Session Signature comprises temporary session parameters.

11. The method of claim 1, wherein the session parameters are server communication identifiers that (a) dynamically change with each new communication session between the computer and the server, and (b) change when the computer communicates with a different server.

12. The method of claim 1, further comprising, if the user chooses to deny access from a specific IP Address more than once, and if that specific IP Address is not in a whitelist of IP addresses, then communicating to the server a notification to block the denied IP address via the server firewall.

13. The method of claim 1, further comprising, upon termination of communication between the user's computer and the server, the step of removing from the database at least one of: the Server Session Signature, the SDWI, and the correlation between the Server Session Signature and SDWI.

14. The method of claim 1, with the proviso that upon termination of communication between the user's computer and the server, the correlation between the Server Session Signature and SDWI removed from the database until the user again interacts with the mobile voice device and allows authentication.

15. The method of claim 1, wherein the user accesses the server using SSH.

16. The method of claim 1, wherein a request by the user for elevated permissions causes steps (g) through (i) to be executed.

17. The method of claim 1, wherein the Server Session Signature comprises only the destination TCP port of the user's computer.

18. The method of claim 1, wherein the session parameters are server communication identifiers specific to the communication between server and the user's computer, and wherein software or hardware identifiers of the user's computer are not transmitted to the TFA platform.

19. The method of claim 1, further comprising the step of monitoring the communication between the user's computer and the server.

20. The method of claim 1, further comprising the step of receiving a notification that the communication between the user's computer and the server has ended.
